(19) United States
(12) Patent Application Publication
(10) Pub. No.: US 2004/0245935 A1
(43) Pub. Date: Dec. 9, 2004

(54) Plasma-processing apparatus

(75) Inventors: Masaaki Takayama, Yamagata (JP); Tadahiro Ogawa, Yamagata (JP)

Correspondence Address: MCGINN & GIBB, PLLC, 8321 OLD COURTHOUSE ROAD, SUITE 200, VIENNA, VA, 22182-3817, US

(73) Assignee: NEC Electronics Corporation, Kawasaki-shi (JP)

(21) Appl. No.: 10/849,448

(22) Filed: May 20, 2004

(30) Foreign Application Priority Data
Jun. 5, 2003 (JP) 2003-160138

(51) Int. Cl. H01J 7/24

(52) U.S. Cl. 315/111.21

(57) ABSTRACT

A plasma processing apparatus includes a vessel structure defining a processing chamber, and an electrode stage provided in the processing chamber. A substrate to be processed is mounted on the electrode stage. The apparatus also includes a first radio frequency current source that supplies the electrode stage with a first radio frequency current which is biased, a radio frequency coil associated with the vessel structure and having a grounded output terminal, and a second radio frequency current source that supplies the radio frequency coil system with a second radio frequency current. A location on a rear surface of the electrode stage, at which the electrode stage is supplied with the first radio frequency current, is positioned at a side of the electrode stage opposed to another side of the electrode stage which is close to the grounded output terminal of the radio frequency coil.

### BACKGROUND OF THE INVENTION

1. Field of the Invention

The present invention generally relates to a plasma processing apparatus, such as a chemical vapor deposition apparatus used in production of a plurality of semiconductor devices in a semiconductor substrate, and more particularly relates to a high-density plasma chemical vapor deposition (HDP-CVD) apparatus, in which both a deposition process and an etching/sputtering process are simultaneously carried out so that a layer, such as an insulating interlayer, a trench-stuffed layer, a passivation layer and so on, is formed as a high grade layer on such a semiconductor substrate.

2. Description of the Related Art

As well known, in a representative process of producing a plurality of semiconductor devices, for example, a silicon wafer is prepared as a semiconductor substrate, and a surface of the silicon wafer is sectioned into a plurality of semiconductor chip areas by forming grid-like fine grooves (i.e. scribe lines) in the silicon wafer. Then, the silicon wafer is processed by various well-known methods such that each of the semiconductor chip areas is produced as a semiconductor device.

In the production of semiconductor devices, for example, various oxide layers, such as an insulating interlayer, a trench-buried layer, a passivation layer and so on, are formed on the silicon wafer, using a plasma processing apparatus, such as a chemical vapor deposition (CVD) apparatus. As a type of CVD apparatus, there is a high-density plasma chemical vapor deposition (HDP-CVD) apparatus, in which both a deposition process and an etching/sputtering process are simultaneously carried out to thereby form an oxide layer as a high grade layer on the silicon wafer.

For example, the HDP-CVD apparatus includes a base member having a recess formed therein, a dome-like roof member securely attached to thereby define a processing chamber, a vacuum exhaust system associated with the base member to create a semi-vacuum state in the processing chamber, and a disk-like electrode stage placed within the tapered recess of the base member, with a silicon wafer to be processed being mounted on the disk-like electrode stage.

Also, the HDP-CVD apparatus is provided with a side RF (radio frequency) coil and a top RF coil which are provided so as to cover the dome-like roof member. Namely, the side RF coil is formed by winding an electric wire around the side wall of the dome-like roof member, and the top RF coil is formed by winding an electric wire on the top wall of the dome-like roof member.

Further, the HDP-CVD apparatus is provided with a first RF current source for supplying the disk-like electrode stage with a biased RF current, a second RF current source for supplying the side RF coil with an RF current, and a third RF current source for supplying the top RF coil with an RF current.

In the HDP-CVD apparatus, for example, when a silicon dioxide layer is formed on the silicon wafer, a silane gas (SiH₄), an argon gas (Ar), and an oxygen gas (O₂) are introduced into the processing chamber through gas injectors provided in the dome-like roof member. By electrically energizing the disk-like electrode stage, the side RF coil, and the top RF coil with the RF currents supplied from the first, second, and third RF current sources, the introduced gases (SiH₄, Ar, and O₂) are excited to thereby generate a plasma.

Thus, silica ions and oxygen ions, included in the plasma, are reacted with each other to thereby produce silicon dioxide, and the produced silicon dioxide is deposited on the silicon wafer W, resulting in formation of the silicon dioxide layer thereon. On the other hand, the silicon dioxide layer is etched or sputtered by the argon ions. Namely, in the HDP-CVD apparatus, both the formation of the silicon dioxide layer and the etching/sputtering of the silicon dioxide layer are simultaneously carried out, and thus it is possible to prevent voids or cavities from forming in the formed silicon dioxide layer. In short, according to the HDP-CVD apparatus, the silicon dioxide layer can be obtained as a high grade layer.

Nevertheless, when the conventional HDP-CVD apparatus is used in production of semiconductor devices in a semiconductor substrate, such as a silicon wafer, a rejection percentage of the produced semiconductor devices is increased, resulting in a decline in the yield rate of the semiconductor devices. According to the inventors' research, it has been found that the increase in the rejection percentage results from the fact that the plasma is unevenly distributed in the processing chamber of the conventional HDP-CVD apparatus, for the reasons stated hereinafter in detail.

The uneven distribution of the plasma causes a high-density-plasma area in the processing chamber, and some semiconductor devices on the silicon wafer are subjected to plasma induced damage in the high plasma density area, resulting in the increase in the rejection percentage of the produced semiconductor devices.

In order to evenly distribute the plasma in the processing chamber, JP-A-2001-155899 suggests that the disk-like electrode stage is surrounded with an auxiliary annular electrode such that an annular plasma is generated beneath the auxiliary annular electrode annular to thereby cause electron drifts between the annular plasma and the plasma generated above the disk-like electrode stage. Namely, the electron drifts contribute toward the even distribution of the plasma generated above the disk-like electrode, and thus it is possible to considerably decrease the rejection percentage of the produced semiconductor devices.

However, the suggestion disclosed in JP-A-2001-155899 is dissatisfied at the provision of the auxiliary annular electrode around the disk-like electrode stage, which results in bulkiness of the HDP-CVD apparatus.

### SUMMARY OF THE INVENTION

Therefore, an object of the present invention is to provide a high-density plasma chemical vapor deposition (HDP-CVD) apparatus, used in production of semiconductor devices in a semiconductor substrate, which is constituted so that a plasma can be more evenly generated and distributed in a processing chamber without bulkiness of the apparatus, to thereby suppress an increase in a rejection percentage of the produced semiconductor devices.

In accordance with the present invention, there is provided a plasma processing apparatus comprising a vessel structure defining a processing chamber, and an electrode stage provided in the processing chamber. A substrate to be processed is mounted on the electrode stage. The plasma processing apparatus further comprises a first radio frequency current source that supplies the electrode stage with a first radio frequency current which is biased, a radio frequency coil associated with the vessel structure and having a grounded output terminal, and a second radio frequency current source that supplies the radio frequency coil system with a second radio frequency current.

According to an aspect of the present invention, a location on a rear surface of the electrode stage, at which the electrode stage is supplied with the first radio frequency current, is positioned at a side of the electrode stage opposed to another side of the electrode stage which is close to the grounded output terminal of the radio frequency coil.

According to another aspect of the present invention, a location on a rear surface of the electrode stage, at which the electrode stage is supplied with the first radio frequency current, is remotely separated from the grounded output terminal of the radio frequency coil, such that a plasma, generated by electrically energizing the electrode stage and the radio frequency coil with the respective first and second radio frequency currents, is distributed as evenly as possible in the processing chamber.

The electrode stage may be formed as a disk-like electrode stage, and the location on the rear surface of the electrode stage, at which the electrode stage is supplied with the first radio frequency current, is substantially diametrically separated from the grounded output terminal of the radio frequency coil with respect to the disk-like electrode stage.

The plasma processing apparatus may comprise a lead wire extended from the first radio frequency current source to the aforesaid location along an outer side of the disk-like electrode stage for an establishment of an electrical connection therebetween.

Preferably, the disk-like electrode stage is formed as an electrostatic-stage-chuck type stage having various elements assembled therein, and parts of the elements are exposed on the rear surface of the electrostatic-stage-chuck type stage. In this case, the lead wire is threaded along the exposed parts so as to be extended from the first radio frequency current source to the aforesaid location.

The vessel structure may have a base member having a tapered space formed therein, and a dome-like roof member securely attached to the base member to thereby define the processing chamber. In this case, preferably, the base member is associated with a vacuum exhaust system having a vacuum pump, such that the tapered space of the base member is in communication with the vacuum pump, and the electrode stage may be positioned in a boundary between the processing chamber and the tapered space.

Preferably, the radio frequency coil is formed as a side radio frequency coil by winding an electric wire around a side wall of the dome-like roof member. In this case, the plasma processing apparatus may further comprise a top radio frequency coil formed by winding an electric wire on a top wall of the dome-like roof member, and a third radio frequency current source that supplies the top radio frequency coil with a third radio frequency current, whereby the plasma is generated as a high density plasma in the processing chamber.

### BRIEF DESCRIPTION OF THE DRAWINGS

The above objects and other objects will be more clearly understood from the description set forth below, with reference to the accompanying drawings, wherein:

FIG. 1 is a longitudinal cross-sectional view showing an embodiment of a high-density plasma chemical vapor deposition (HDP-CVD) apparatus according to the present invention;

FIG. 2 is a cross-sectional view taken along the II-II line of FIG. 1, explaining a location at which a disk-like electrode stage is supplied with a biased RF (radio frequency) current in the HDP-CVD apparatus according to the present invention;

FIG. 3 is a rear view observed along the III-III line of FIG. 1, showing a rear surface of the disk-like electrode stage of the HDP-CVD apparatus shown in FIG. 2;

FIG. 4 is a cross-sectional view, corresponding to FIG. 2, explaining a location at which a disk-like electrode stage is supplied with a biased RF (radio frequency) current is supplied in a conventional HDP-CVD apparatus;

FIG. 5 is a rear view, corresponding to FIG. 3, showing a rear surface of the disk-like electrode stage shown in FIG. 4;

FIG. 6 is a cross-sectional view, similar to FIG. 4, conceptually illustrating electromagnetic waves generated in the conventional HDP-CVD apparatus;

FIG. 7 is a plan view conceptually showing a silicon wafer processed by the conventional HDP-CVD apparatus, each of defective products being shown as a hatching area;

FIG. 8 is a cross-sectional view, similar to FIG. 2, conceptually illustrating electromagnetic waves generated in the HDP-CVD apparatus according to the present invention;

FIG. 9 is a plan view conceptually showing a silicon wafer processed by the HDP-CVD apparatus according to the present invention;

FIG. 10 is a partial perspective view illustrating one of metal oxide semiconductor field effect transistor (MOSFET) devices produced in a silicon wafer; and

FIG. 11 is a graph showing a relationship between a rejection percentage of produced MOSFET devices and an antenna ratio when using the conventional HDP-CVD apparatus and the HDP-CVD apparatus according to the present invention.

### DESCRIPTION OF THE PREFERRED EMBODIMENTS

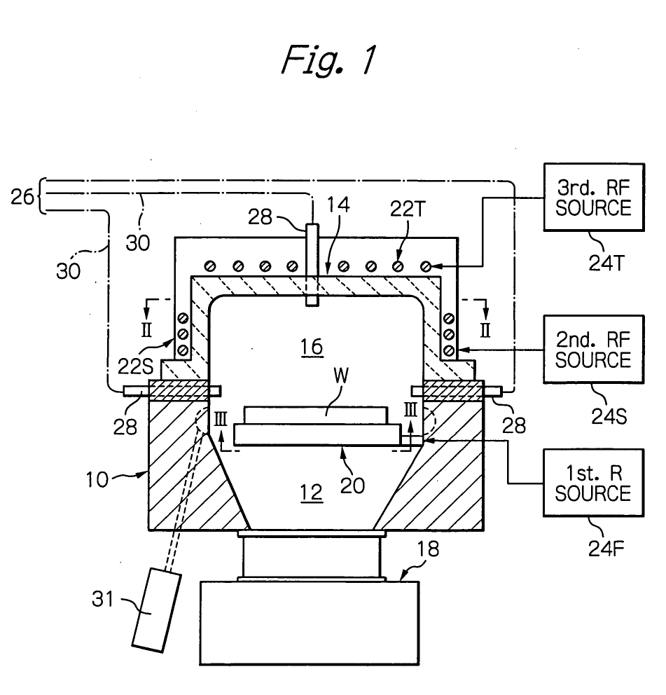

With reference to FIG. 1, a high-density plasma chemical vapor deposition (HDP-CVD) apparatus is schematically illustrated. This HDP-CVD apparatus is used to form various layers, such as an insulating interlayer, a trench-buried layer, a passivation layer and so on, on a semiconductor substrate in production of semiconductor devices.

As shown in FIG. 1, the HDP-CVD apparatus includes a vessel structure which has a base member 10 having a tapered space 12 formed therein, and a dome-like roof member 14 securely attached to the base member 10 to thereby define a processing chamber 16. The base member 10 is made of a suitable metal material, such as aluminum, and the dome-like roof member 14 is made of a suitable ceramic material. The HDP-CVD apparatus also includes a vacuum exhaust system 18 having a vacuum pump, such as a turbo-pump, and the base member 10 is securely mounted on the vacuum exhaust system 18 such that the tapered space 12 of the base member 10 is in communication with the turbo-pump of the vacuum exhaust system 18.

The HDP-CVD apparatus further includes a disk-like electrode stage 20, which is provided in the tapered space of the base member 10, and a silicon wafer W to be processed is mounted on the disk-like electrode stage 20. Preferably, as shown in FIG. 1, the disk-like electrode stage 20 is positioned at a boundary between the tapered space 12 of the base member 10 and the processing chamber 16 defined by dome-like roof member 14. In this embodiment, the disk-like electrode stage 20 is formed as an ESC (electrostatic-stage-chuck) type stage, and the silicon wafer W is electrostatically chucked on the ESC type stage 20 while a CVD process is performed in the HDP-CVD apparatus.

Also, the HDP-CVD apparatus is provided with a side RF (radio frequency) coil 22S and a top RF coil 22T which are provided so as to cover the dome-like roof member 14. Namely, the side RF coil 22S is formed by winding an electric wire around the side wall of the dome-like roof member 14, the top RF coil 22T is formed by winding an electric wire on the top wall of the dome-like roof member 14.

Further, the HDP-CVD apparatus is provided with a first RF current source 24F for supplying the disk-like ESC type stage with an RF current biased to the plus-side, a second RF current source 24S for supplying the side RF coil 22S with an RF current, and a third RF current source 24T for supplying the top RF coil 22T with an RF current, which is smaller than the RF current supplied from the second RF current source 24S to the side RF coil 22S.

The HDP-CVD apparatus includes a gas feeder system, generally indicated by reference 26, for feeding various reaction gases to the processing chamber 16. Namely, the gas feeder system 26 includes a plurality of gas injectors 28 provided in the dome-like roof member 14, which are connected to gas sources (not shown) through gas feeder pipes 30, which are represented by chain-dot lines in FIG. 1.

The HDP-CVD apparatus also includes a cleaning system, which includes an applicator 31 for introducing a cleaning gas, such as nitrogen trifluoride (NF₃), into the processing chamber 16. In particular, when a CVD process is performed in the HDP-CVD apparatus, a part of products, produced in the CVD process, is deposited onto an inner wall of the processing chamber 16. Thus, after the CVD process is completed in the HDP-CVD apparatus, while the HDP-CVD apparatus is operated, the cleaning gas, such as nitrogen trifluoride (NF₃), is introduced into the processing chamber 16 through the applicator 31, to thereby removing the residual deposition from the inner wall of the processing chamber 16.

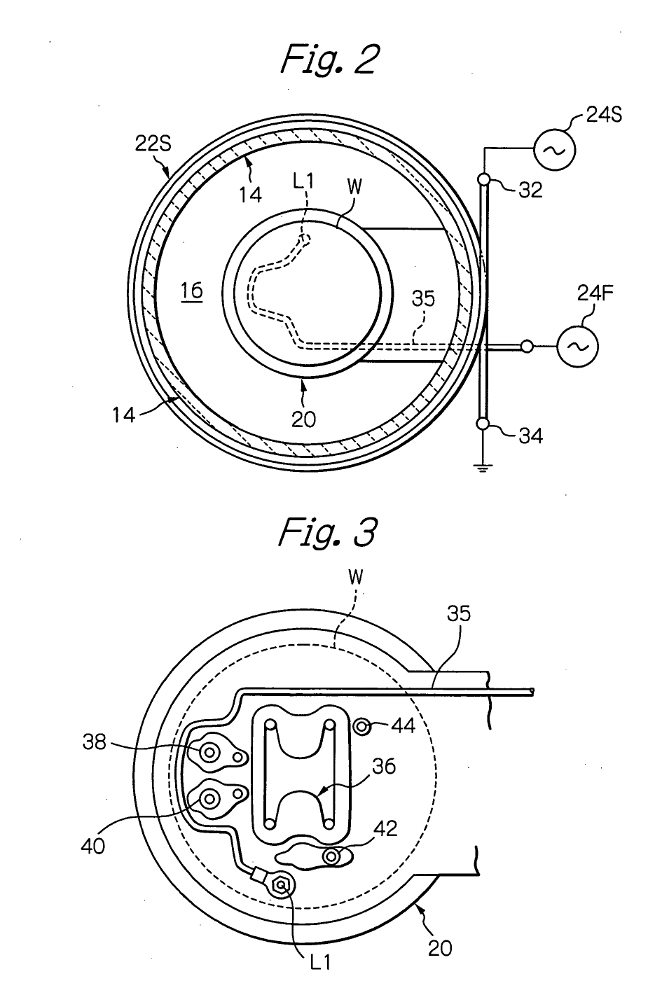

As shown in FIG. 2 in which the first and second RF current sources 24F and 24S are symbolically illustrated, one end of the side RF coil 22S is connected as an input terminal 32 to the second RF current source 24S, and the other end thereof is grounded as an output terminal 34. As is apparent from FIG. 2, the output terminal 34 of the side RF coil 22S is inevitably located at a position beside the dome-like roof member 14 defining the processing chamber 16, due to a constructional constraint of the HDP-CVD apparatus.

On the other hand, as shown in FIGS. 2 and 3, according to the present invention, an electrical connection between the disk-like ESC type stage 20 and the first RF current source 24F is established at a location L1 on the rear surface of the disk-like ESC type stage 20. Namely, a lead wire 35 is extended from the first RF current source 24F to the location L1 for the establishment of the electrical connection therebetween.

As is apparent from FIGS. 2 and 3, according to the present invention, the location L1 is positioned at a side of the disk-like ESC type stage 20 opposed to another side of the disk-like ESC type stage 20 which is close to the grounded output terminal 34 of the side radio frequency coil 22S. Namely, the location L1 is remotely separated from the grounded output terminal 34 of the side RF coil 22S. In other words, the location L1 is substantially diametrically separated from the grounded output terminal 34 of the side radio frequency coil 22S with respect to the disk-like ESC type electrode stage 20.

By the way, various elements are assembled in the disk-like ESC type stage 20, and parts of the elements are exposed on the rear surface of the ESC type stage 20, as shown in FIG. 3. Namely, in this drawing, reference 36 indicates a part of a lift-pin mechanism for lifting the silicon wafer W; respective references 38 and 40 indicate a cooling-water inlet port and a cooling-water outlet port of a cooling system for the ESC type stage 20; reference 42 indicates a helium-gas inlet port of a cooling system for the silicon wafer W; and reference 44 indicates a part of a temperature-monitoring system for the silicon wafer W.

Nevertheless, according to the present invention, the lead wire 35 is threaded along the various parts, exposed on the rear surface of the disk-like ESC type stage 20, so as to be extended from the first RF current source 24F to the location L1, which is remotely separated from the output terminal 34 of the side RF coil 22S, for the reasons stated hereinbefore in detail.

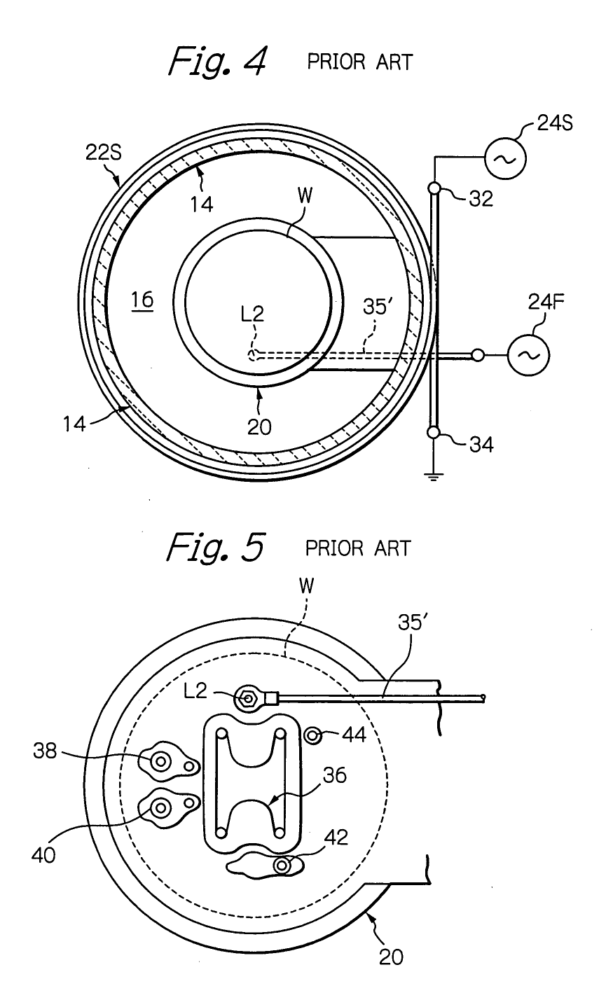

With reference to each of FIGS. 4 and 5, corresponding to FIGS. 2 and 3, a significant part of a conventional HDP-CVD apparatus is shown for better understanding of the present invention. Note, in these drawings, the same references as in FIGS. 2 and 3 represent the same features.

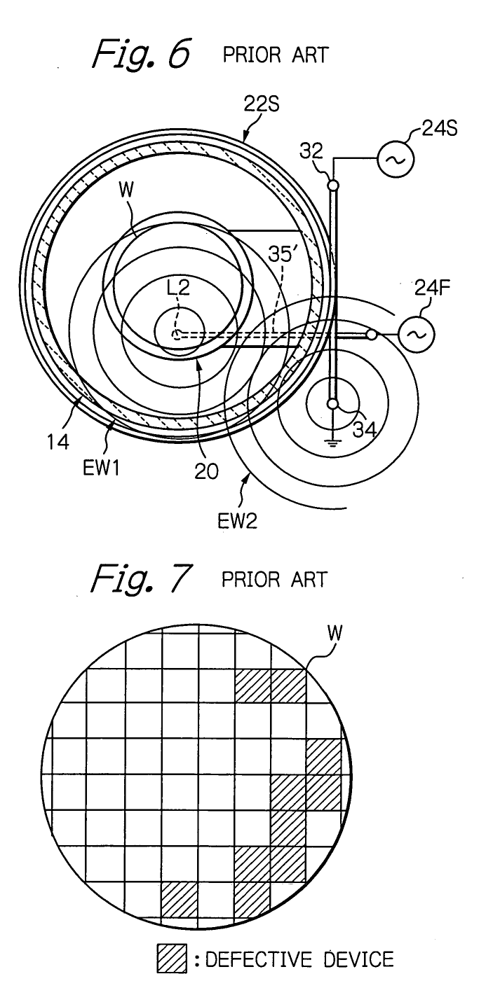

As shown in FIGS. 4 and 6, conventionally, an electrical connection between the disk-like ESC type stage 20 and the first RF current source 24F is established at a location L2 on the rear surface of the disk-like ESC type stage 20, which is relatively close to the output terminal 34 of the side RF coil 22S. Namely, a lead wire 35′ is extended from the first RF current source 24F to the location L2 for the establishment of the electrical connection therebetween. In short, the location L2 is selected as an easy access location without threading the lead wire 35′ along the various parts, exposed on the rear surface of the disk-like ESC type stage 20.

In either event, in operation, the disk-like ESC type stage 20, the side RF coil 22S, and the top RF coil 22T are electrically energized with the RF currents supplied from the first, second and third RF current sources 24F, 24S, and 24T, respectively.

For example, when a silicon dioxide layer is formed on the silicon wafer W in the HDP-CVD apparatus, first, a semi-vacuum state is produced in the processing chamber 16 by driving the turbo-pump of the vacuum exhaust system 18, and a silane gas (SiH₄), an argon gas (Ar), and an oxygen gas (O₂) are introduced into the processing chamber 16 through the gas injectors 28 provided in the dome-like roof member 14. By the electrical energization of the disk-like ESC type stage 20, the side RF coil 22S, and the top RF coil 22T with the RF currents, the introduced gases (SiH₄, Ar, and O₂) are excited to thereby generate a plasma.

Thus, silica ions and the oxygen ions, included in the plasma, are reacted with each other to thereby produce silicon dioxide, and the produced silicon dioxide is deposited on the silicon wafer W, resulting in formation of the silicon dioxide layer thereon. On the other hand, the silicon dioxide layer is etched or sputtered by the argon ions. Namely, in the HDP-CVD apparatus, both the formation of the silicon dioxide layer and the etching/sputtering of the silicon dioxide layer are simultaneously carried out, and thus it is possible to prevent voids or cavities from forming in the formed silicon dioxide layer. In short, according to the HDP-CVD apparatus, the silicon dioxide layer can be obtained as a high grade layer.

However, when the conventional HDP-CVD apparatus shown in FIGS. 4 and 5 is used in production of semiconductor devices in a silicon wafer, a rejection percentage of the produced semiconductor devices is increased because the plasma is unevenly distributed in the processing chamber 16.

In particular, while the ESC type stage 20 and the side RF coil 22S are electrically energized with the RF currents supplied from the respective first and second RF current sources 24F and 24S, a first electromagnetic wave EW1 is generated from the location L2, at which the end of the lead wire 35′ is connected to the ESC type stage 20, and a second electromagnetic wave EW2 is generated from the output terminal 34 of the side RF coil 22S, as shown in FIG. 6. Conventionally, since the location L2 is relatively close to the output terminal 34 of the side RF coil 22S, the first and second electromagnetic waves EW1 and EW2 overlap with each other at an area between the location L2 and the output terminal 34. Namely, the area between the location L2 and the output terminal 34 is created as an electromagnetic-wave-strengthened area at which a density of the plasma is considerably enhanced, and thus the plasma is unevenly distributed in the processing chamber 16 of the conventional HDP-CVD apparatus.

Of course, the creation of the electromagnetic-wave-strengthened area or high-density plasma area should be prevented because semiconductor devices on the silicon wafer W may be subjected to plasma induced damage in the high-density plasma area.

In reality, when a silicon wafer (W) was processed by the conventional HDP-CVD apparatus, some semiconductor devices on the silicon wafer (W), were produced as defective semiconductor devices, and these defective semiconductor devices were concentrated in the electromagnetic-wave-strengthened area or high-density plasma area, as shown in FIG. 7 in which each of the defective semiconductor devices are illustrated as a hatching area. This proves that the production of the defective semiconductor devices results from the plasma induced damage.

Note, although an electromagnet wave is generated from an output terminal (not shown) of the top RF coil 22T, it is hardly influences a horizontal distribution of the plasma produced above the disk-like ESC type stage 20 in the processing chamber 16.

On the other hand, when the HDP-CVD apparatus according to the present invention, as shown in FIGS. 2 and 3, is used in production of semiconductor devices in a silicon wafer, a rejection percentage of the produced semiconductor devices is considerably decreased because the plasma is not extremely unevenly distributed in the processing chamber 16.

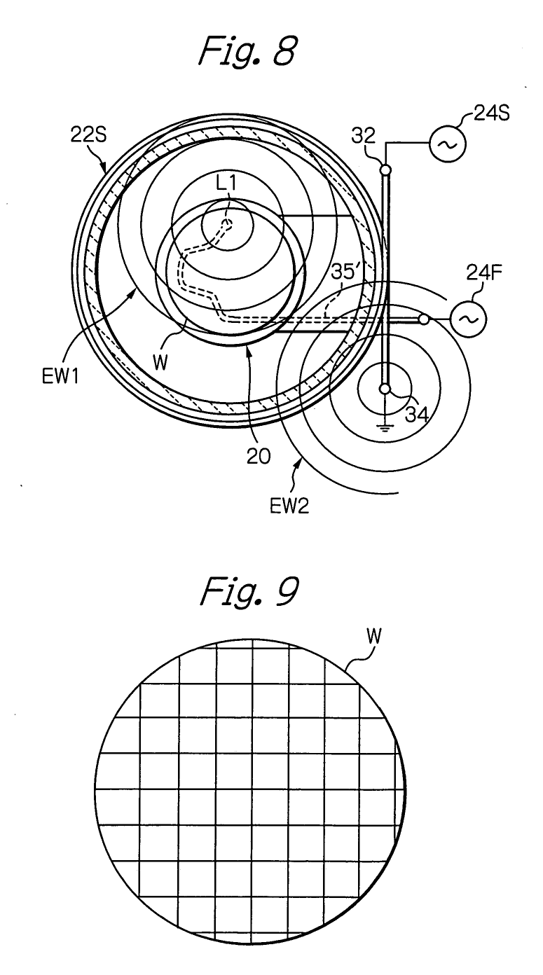

In particular, while the ESC type stage 20 and the side RF coil 22S are electrically energized with the RF currents supplied from the respective first and second RF current sources 24F and 24S, a first electromagnetic wave EW1 is generated from the location L2, at which the end of the lead wire 35 is connected to the ESC type stage 20, and a second electromagnetic wave EW2 is generated from the output terminal 34 of the side RF coil 22S, as shown in FIG. 8. According to the present invention, since the location L2 is remotely separated from the output terminal 34 of the side RF coil 22S, the first and second electromagnetic waves EW1 and EW2 do not create an electromagnetic-wave-strengthened area at which a density of the plasma is considerably enhanced, and thus the plasma is relatively evenly distributed in the processing chamber 16 of the HDP-CVD apparatus according to the present invention. Accordingly, the semiconductor devices on the silicon wafer W cannot be subjected to the plasma induced damage.

In reality, when a silicon wafer (W) was processed by the HDP-CVD apparatus according to the present invention, defective semiconductor devices were hardly produced in the silicon wafer (W), as shown in FIG. 9.

For example, when a HDP-CVD apparatus is used in production of a plurality of metal oxide semiconductor field effect transistor (MOSFET) devices in a silicon wafer (W), the MOSFET devices may be subjected to plasma induced damage.

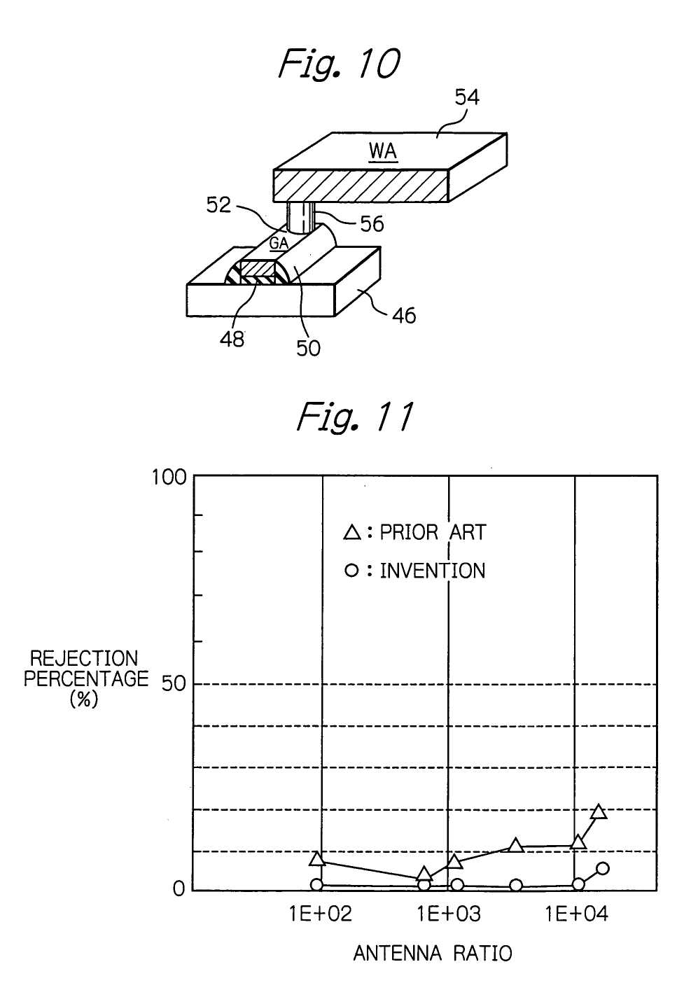

With reference to FIG. 10, one of the MOSFET devices is representatively illustrated in a partial perspective view. As well known, the MOSFET device includes a semiconductor substrate 46 defined as a part of the silicon wafer (W), a silicon dioxide layer 48 formed on the semiconductor substrate 46, an insulating side wall 50 surrounding the silicon dioxide layer 48, a gate electrode layer 52 formed on the silicon dioxide layer 48, and a wiring layer 54 disposed above the gate electrode layer 52. Although not illustrated in FIG. 10, an insulating layer is formed on the semiconductor substrate 46 such that the annular side wall 50 and the gate electrode layer 52 are covered with the insulating layer, and the wiring layer 54 is formed on the insulating layer. The gate electrode layer 52 is electrically connected to the wiring layer 54 through a via plug 56 formed in the insulating layer.

In this case, an antenna ratio is frequently used as a significant parameter for evaluating the plasma induced damage, to which the MOSFET devices may be subjected. The antenna ratio is defined as a ratio of an area WA of the wiring layer 54 to an area GA of the gate electrode layer 52. For example, while the silicon wafer (W) is processed in the HDP-CVD apparatus to form a silicon dioxide insulating layer on the wiring layer 54, the forming silicon electrode insulating layer is charged with electrons, so that a tunnel current may flow through the silicon dioxide layer 48 in accordance with an magnitude of the antenna ratio WA/GA, resulting in deterioration of the silicon dioxide layer 48. Namely, the MOSFET devices may be subjected to the plasma induced damage in accordance with the magnitude of the antenna ratio WA/GA. In short, the larger the antenna ratio WA/GA, the severer the plasma induce damage.

In order to investigate the relationship between a rejection percentage and an antenna ratio, a plurality of MOSFET devices were experimentally produced in a silicon wafer (W), using the conventional HDP-CVD apparatus shown in FIGS. 4 and 5, and a plurality of MOSFET devices were experimentally produced in a silicon wafer (W), using the HDP-CVD according to the present invention.

The experimental results are shown in a graph of FIG. 11. As is apparent from this graph, when the HDP-CVD apparatus according to the present invention was used, there were substantially no MOSFET devices to be rejected in a range from the antenna ratio 1E+02 to the antenna ratio 1E+04. On the other hand, when the conventional HDP-CVD apparatus was used, a rejection percentage of the produced MOSFET devices was considerably increased.

Thus, by using the HDP-CVD apparatus according to the present invention, it is possible to produce semiconductor devices at a high yield rate.

In the above-mentioned embodiment, although the present invention is applied to the HDP-CVD apparatus, it is possible to embody the concept of the present invention in another plasma processing apparatus, such as a usual CVD apparatus, a plasma etching apparatus, a sputtering apparatus or the like.

Finally, it will be understood by those skilled in the art that the foregoing description is of a preferred embodiment of the apparatus, and that various changes and modifications may be made to the present invention without departing from the spirit and scope thereof.

1. A plasma processing apparatus comprising:
a vessel structure defining a processing chamber;
an electrode stage provided in said processing chamber, a substrate to be processed being mounted on said electrode stage;
a first radio frequency current source that supplies said electrode stage with a first radio frequency current which is biased to a plus-side;
a radio frequency coil associated with said vessel structure and having a grounded output terminal; and
a second radio frequency current source that supplies said radio frequency coil system with a second radio frequency current,
wherein a location on a rear surface of said electrode stage, at which said electrode stage is supplied with said first radio frequency current, is positioned at a side of said electrode stage opposed to another side of said electrode stage which is close to the grounded output terminal of said radio frequency coil.

2. A plasma processing apparatus as set forth in claim 1, wherein said electrode stage is formed as a disk-like electrode stage, and the location on the rear surface of said electrode stage, at which said electrode stage is supplied with said first radio frequency current, is substantially diametrically separated from the grounded output terminal of said radio frequency coil with respect to said disk-like electrode stage.

3. A plasma processing apparatus as set forth in claim 2, further comprising a lead wire extended from the first radio frequency current source to said location along an outer side of said disk-like electrode stage for an establishment of an electrical connection therebetween.

4. A plasma processing apparatus as set forth in claim 2, wherein said disk-like electrode stage is formed as an electrostatic-stage-chuck type stage having various elements assembled therein, and parts of said elements are exposed on the rear surface of said electrostatic-stage-chuck type stage, said lead wire being threaded along said exposed parts so as to be extended from the first radio frequency current source to said location.

5. A plasma processing apparatus as set forth in claim 1, wherein said vessel structure has a base member having a tapered space formed therein, and a dome-like roof member securely attached to said base member to thereby define said processing chamber, said base member being associated with a vacuum exhaust system having a vacuum pump, so that the tapered space of said base member is in communication with said vacuum pump, said electrode stage being positioned in a boundary between said processing chamber and said tapered space.

6. A plasma processing apparatus as set forth in claim 5, wherein said radio frequency coil is formed as a side radio frequency coil by winding an electric wire around a side wall of said dome-like roof member.

7. A plasma processing apparatus as set forth in claim 6, further comprising:
a top radio frequency coil formed by winding an electric wire on a top wall of said dome-like roof member; and
a third radio frequency current source that supplies said top radio frequency coil with a third radio frequency current, whereby said plasma is generated as a high density plasma in said processing chamber.

8. A plasma processing apparatus comprising:
a vessel structure defining a processing chamber;
an electrode stage provided in said processing chamber, a substrate to be processed being mounted on said electrode stage;
a first radio frequency current source that supplies said electrode stage with a first radio frequency current which is biased to a plus-side;
a radio frequency coil associated with said vessel structure and having a grounded output terminal; and
a second radio frequency current source that supplies said radio frequency coil system with a second radio frequency current,
wherein a location on a rear surface of said electrode stage, at which said electrode stage is supplied with said first radio frequency current, is remotely separated from the grounded output terminal of said radio frequency coil, such that a plasma, generated by electrically energizing said electrode stage and said radio frequency coil with said respective first and second radio frequency currents, is distributed as evenly as possible in said processing chamber.

9. A plasma processing apparatus as set forth in claim 8, wherein said electrode stage is formed as a disk-like electrode stage, and the location on the rear surface of said electrode stage, at which said electrode stage is supplied with said first radio frequency current, is substantially diametrically separated from the grounded output terminal of said radio frequency coil with respect to said disk-like electrode stage.

10. A plasma processing apparatus as set forth in claim 9, further comprising a lead wire extended from the first radio frequency current source to said location along an outer side of said disk-like electrode stage for an establishment of an electrical connection therebetween.

11. A plasma processing apparatus as set forth in claim 9, wherein said disk-like electrode stage is formed as an electrostatic-stage-chuck type stage having various elements assembled therein, and parts of said elements are exposed on the rear surface of said electrostatic-stage-chuck type stage, said lead wire being threaded along said exposed parts so as to be extend from the first radio frequency current source to said location.

12. A plasma processing apparatus as set forth in claim 8, wherein said vessel structure has a base member having a tapered space formed therein, and a dome-like roof member securely attached to said base member to thereby define said processing chamber, said base member being associated with a vacuum exhaust system having a vacuum pump, such that the tapered space of said base member is in communication with said vacuum pump, said electrode stage being positioned in a boundary between said processing chamber and said tapered space.

13. A plasma processing apparatus as set forth in claim 12, wherein said radio frequency coil is formed as a side radio frequency coil by winding an electric wire around a side wall of said dome-like roof member.

14. A plasma processing apparatus as set forth in claim 13, further comprising:
a top radio frequency coil formed by winding an electric wire on a top wall of said dome-like roof member; and
a third radio frequency current source that supplies said top radio frequency coil with a third radio frequency current, whereby said plasma is generated as a high density plasma in said processing chamber.
